(19) United States
(12) Patent Application Publication
(10) Pub. No.: US 2007/0031128 A1
(43) Pub. Date: Feb. 8, 2007

(54) Video recording apparatus, integrated video capturing/recording apparatus, and audio/video editing system

(75) Inventors: Kaishin Go, Beijing (CN); Yue Lu, Beijing (CN)

Correspondence Address: VENABLE LLP, P.O. BOX 34385, WASHINGTON, DC, 20043-9998, US

(73) Assignee: HDAVS CO., LTD., Beijing (CN)

(21) Appl. No.: 11/498,277

(22) Filed: Aug. 3, 2006

(30) Foreign Application Priority Data
Aug. 4, 2005 (CN) 200510089153.9

(51) Int. Cl. H04N 5/00

(52) U.S. Cl. 386/125

(57) ABSTRACT

The invention provides a video recording apparatus, an integrated video capturing/recording apparatus, and an audio/video editing system. Wherein, the audio/video editing system includes a data editing unit, a display output unit, a control input unit, and an iVDR adapter; the data editing unit is configured to edit audio/video data, and is connected to the display output unit; the control input unit is connected to the data editing unit, so that the data editing unit obtains signals from the control input unit and performs the corresponding data editing operations; the iVDR adapter is connected to the data editing unit via Serial ATA (S-ATA) interfaces. The invention implements digitalized program acquisition, recording, and editing.

### FIELD OF THE INVENTION

The invention relates to a broadcast television system, particularly to a audio/video editing system and an integrated video capturing/recording apparatus.

### BACKGROUND OF THE INVENTION

Since television was invented, magnetic tapes have been taking an important role as television signal recording medium and television program bearer; a magnetic tape-based linear recording and editing process has been used up to now. The linear recording and editing refers to: the recording and editing sequences of television signals matches strictly to the sequence of physical positions on the magnetic tape, the sequence of programs can't be changed once programs are recorded.

Magnetic tape-based linear editing refers to copy specified segments of a program on a magnetic tape containing raw data to another magnetic tape as required and then copy (edit) the segments in the sequence required by the program, so as to accomplish program editing; after the editing, the sequence of the program segments can't be changed, and any of the segments can't be deleted, but can be replaced. That technical scheme has drawbacks, such as poor special effects, poor image forms, possible damage or destroy of the magnetic tape containing raw data, quality degradation in duplication, and video recorder head wear, etc.

As computer technology develops, nonlinear editing has been widely used and has overcome some drawbacks in the foresaid linear editing to a certain degree. The nonlinearity refers to: the storage sequence of television programs may not match the sequence of physical positions on the storage medium (for example, hard disk), i.e., a program can include multiple segments and be distributed in several different physical areas.

At present, there is a nonlinear editing system available in the market, which supports nonlinear editing with only magnetic tapes as program source. That is to say, a camera obtains program data and stores them on a magnetic tape; the audio/video data on the magnetic tape are digitalized and stored into the hard disk of a computer by a recorder and a nonlinear editing system for nonlinear editing; finally, the nonlinearly edited program is output to the magnetic tape.

It is seen from the above description that the existing program production equipment can't directly provide program data that can be recognized and processed by computer; even in the nonlinear editing system, program input and output have to be accomplished with magnetic tapes as the storage medium; consequently, the introduction of the nonlinear editing system only reduces tape duplication cycles but can't eliminate program signal loss associated with tape duplication; therefore, the nonlinear editing equipment can't solve the problem of signal loss in the television program editing process completely; furthermore, the raw data on magnetic tape has to be acquired into the nonlinear editing system in 1:1 real time; however, in actual operations, the raw data has to be downloaded by scene sometimes; as the result, the required editing time often is several times longer than the actual time length of the program.

In conclusion, the existing equipment can't provide program data that can be directly recognized by computer in television program data acquisition and recording; as the result, data conversion between storage media still exists in the television program production process, resulting in loss of television program signals, complex production process, and degraded efficiency of program production.

### SUMMARY OF THE INVENTION

The present invention aims to provide a video recording apparatus, an integrated video capturing/recording apparatus, and a nonlinear editing system; the apparatuses are configured to implement digital program data acquisition, recording, and editing.

To solve the technology problems mentioned above, with the present invention provide the following technical schemes:

In an aspect of the present invention, there is provided a video recording apparatus, including: an interface unit, configured to provide external program data input/output (I/O) interfaces; a video recording control unit, configured to control the input/output of program data according to external control signals; and an Information Versatile Disk for Removable usage (iVDR) adapter, connected to the video recording control unit via Serial ATA (S-ATA) interfaces and configured to read/write program data from/to iVDR storage devices under control of the video recording control unit.

The iVDR storage devices may be iVDR hard disks and iVDR standard-compliant semiconductor cards.

The video recording apparatus accesses the two storage devices simultaneously by utilizing RAID 1 technology.

The video recording apparatus further includes a display output unit, configured to be connected to the video recording control unit via the interface unit and to display images.

In another aspect of the present invention, there is provided an integrated video capturing/recording apparatus, including an audio/video capturing and processing system and an audio/video recording system; the audio/video recording system includes: a video recording control unit, configured to obtain external control signals and connected to the audio/video capturing and processing system to obtain audio/video data from the audio/video capturing and processing system; iVDR adapter, connected to the video recording control unit via Serial ATA (S-ATA) interfaces and configured to read/write program data from/to the storage devices.

The storage devices may be iVDR hard disks or iVDR standard-compliant semiconductor cards.

The integrated video capturing/recording apparatus accesses the two storage devices simultaneously by utilizing RAID 1 technology.

The integrated video capturing/recording apparatus further includes an audio/video output unit, which is connected to the video recording control unit and configured to display video images or output audio under control of the video recording control unit.

The integrated video capturing/recording apparatus further includes a data interface unit, which is connected to the video recording control unit to provide external serial interfaces.

In a further aspect of the present invention, there is provided an audio/video editing system, including: a data editing unit, a display output unit, a control input unit, and an iVDR adapter; the data editing unit is configured to edit audio/video data and is connected to the display output unit; the control input unit is connected to the data editing unit, so that the data editing unit obtains signals from the control input unit and performs corresponding data editing operations; the iVDR adapter is connected to the data editing unit via Serial ATA (S-ATA) interfaces.

Based on the above system structure, the audio/video editing system further includes: an audio/video data processing unit and an audio/video interface unit; the audio/video data processing unit is connected to the data editing unit through a serial bus, and is configured for the conversion between the audio/video (AV) signals and the data that can be recognized by the data editing unit; the audio/video interface unit is connected to the audio/video data processing unit through audio/video signal cables, and is configured to provide external audio/video input/output (I/O) interfaces.

Specifically, the control input unit is a keyboard or a mouse connected to the data editing unit through a serial data bus.

The control input unit further includes an editing control input unit connected to the data editing unit via a serial interface to provide external linear editing control keys and nonlinear editing control keys; the data editing unit receives instructions from the editing control input unit and maps the instructions to operating instructions of the data editing unit and performs corresponding data editing operations.

The audio/video editing system further includes an infrared receive unit configured to receive control signals from an infrared keyboard or mouse and send the control signals to the data editing unit through the serial data bus; in addition, the audio/video editing system further includes a data interface unit, which is connected to the data editing unit to provide external serial interfaces; in addition, the data interface unit can further provide an Ethernet interface.

It is seen from above technical schemes that: since the video recording apparatus and the integrated video capturing/recording apparatus provided in the present invention provide an iVDR adapter respectively, iVDR hard disks or iVDR standard-compliant semiconductor cards, featured with high access speed, high capacity, and low cost, can be used as the storage media in the television program production process; in addition, thanks to the hot-swapping feature of the iVDR hard disks and the semiconductor cards, online/offline switching during program production is much quicker, and thereby can meet the requirement of nonlinear editing directly on the hard disk containing raw data; furthermore, the present invention employs RAID 1 technology to write program data to two storage devices simultaneously and thereby implement backup for program data acquisition. In conclusion, the invention can implement full digitalization across the broadcast television program production process.

The audio/video editing system provided in the present invention also provides an iVDR adapter, so that iVDR hard disks or iVDR standard-compliant semiconductor cards, featured with high access speed, high capacity, and low cost, can be used as the storage media in the television program editing process; in addition, thanks to the hot-swapping feature of the iVDR hard disks and the semiconductor cards, the online/offline switching in program production is much quicker and thereby can meet the requirement of nonlinear editing directly on the hard disk containing raw data; as the result, the audio/video editing system has the advantages of nonlinear editing, including random access of raw data and integrated composition and production.

Furthermore, the audio/video editing system also provides an audio/video data processing unit, an audio/video interface unit, and an editing control input unit that provides control keys for linear editing and nonlinear editing, so that the system can be connected not only to other devices for nonlinear editing but also to a linear editing system for linear editing; therefore, the system inherits the advantages of linear editing system and is more suitable for technicians familiar with linear editing system; in addition, the system implements smooth transition from linear editing to nonlinear editing of television programs and avoids waste of resources in the existing linear editing system.

### BRIEF DESCRIPTION OF THE DRAWINGS

FIG. 1 is a schematic diagram of structure of the video recording apparatus according to an embodiment of the present invention;

FIG. 2 is a schematic diagram of interfaces of the integrated video capturing/recording apparatus according to an embodiment of the present invention;

FIG. 3 is a logic diagram of structure of the audio/video editing system according to an embodiment of the present invention;

FIG. 4 shows the audio/video editing system according to a preferred embodiment of the present invention.

### DETAILED DESCRIPTION OF THE EMBODIMENTS

The video recording apparatus according to an embodiment of the present invention is described hereunder with reference to FIG. 1; wherein the video recording apparatus includes:

interface unit 12, which provides external audio/video signal Input/Output (I/O) interfaces;

video recording control unit 11, which obtains or outputs program data via the interface unit; the program data usually includes video data (e.g., MPEG 2 code stream) and audio data (e.g., PCM code stream); in addition, the video recording control unit 11 controls input/output of the program data with external control signals;

iVDR adapter 13, including: an iVDR (Information Versatile Disk for Removable usage) standard interface, configured to supply power to the hard disk and perform communication and data transmission when an iVDR storage device is connected to the interface; a slot for iVDR storage device; and an electromechanical means or a manual means configured to secure the iVDR storage device to the slot, so that the storage device is connected firmly to the iVDR interface in the adapter. The iVDR adapter is connected to the video recording control unit via a Serial ATA (S-ATA) interface provided by the interface unit and is used to read/write program data from/to the storage device under the control of the video recording control unit; in the storage devices iVDR hard disk and iVDR-compliant semiconductor cards can be used to record program data at the same time, and the program data can be accessed from the two storage media at the same time; therefore, multiple storage devices can serve as backup for each other, to ensure sufficient data safety;

The being accessed from the two storage media at the same time in the above embodiment employs RAID 1 technology to access the two storage devices at the same time. the RAID 1 is also referred to as Mirror or Mirroring, which implements data redundancy by means of data mirroring to produce mutual-backup data on two separate hard disks; RAID 1 can improve data retrieving performance, i.e., when the hard disk containing original data is busy, the data can be retrieved directly from the mirrored copy. RAID 1 provides highest data availability; in case one of the hard disk fails, the system can switch to the mirroring disk automatically instead of restructuring the corrupted data. The RAID 1 is a well known technology in the field;

In an further embodiment of the present invention, when two storage devices are connected to the video recording control unit via the iVDR adapter, data can be written to the first and the second storage devices simultaneously with RAID 1 technology in case that the space of the first storage device is to be used up; and after the first storage device is full, it can be replaced with a third storage device, so as to implement long-time uninterrupted program data recording; or, the program data can be stored into a buffer unit before it is written to the storage devices, so that the buffer unit can buffer the acquired program data in case that the space in the first storage unit is used up, and, when the second storage device is put into service, the program data in the buffer unit can be written into the second storage device; that method in the embodiment can also implement uninterrupted program data recording;

Display output unit 14, which is connected to the video recording control unit via a Video Graphics Array (VGA) interface or a Digital Visual Interface (DVI) interface provided by the interface unit to display images, and can also display operating interface of the video recording apparatus.

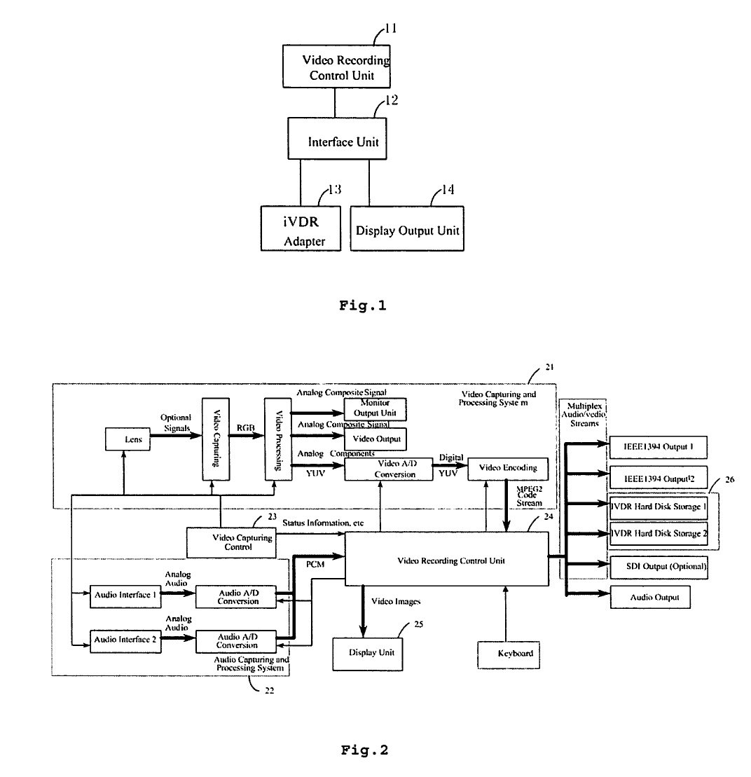

The integrated video capturing/recording apparatus according to an embodiment of the present invention is described hereunder with reference to FIG.2.

As shown in FIG.2, the integrated video capturing/recording apparatus in the embodiment includes video capturing and processing system 21 and audio capturing and processing system 22, video capturing control unit 23, and video recording control unit 24.

In the video capturing and processing system, the lens sends the captured optical signals to the video capturing unit under control of the video capturing control unit 23; the video capturing unit acquires the optical signals and sends the acquired RGB signals to the video processing unit; the video processing unit processes the RGB signals (gamma correction and white balance, etc.) and outputs analog composite signals to the monitor output unit and video output unit; the monitor output unit is configured to monitor the output from the integrated video capturing/recording apparatus during the video capturing process to verify the apparatus operates normally; the video output unit is configured to output the video signals to an external video recorder or similar devices for further processing; in addition, after the video processing unit processes the RGB signals, it sends the resulting analog YUV components to the video analog-to-digital (A/D) unit; under the control of the video recording control unit, the video A/D unit converts the analog YUv components into digital YUV signals and sends them to the video encoding unit; in this embodiment, the video encoding unit performs MPEG2 encoding for the digital YUV signals and sends the resulting MPEG-2 code stream to the video recording control unit 24 as the output from the video capturing and processing system.

As shown in FIG. 2, under the control of the video capturing control unit, the audio capturing and processing unit capture audio signals via two audio interfaces (audio interface 1 and audio interface 2) and sends the acquired two channels of analog audio signals to two audio analog-to-digital (A/D) units; the two audio A/D units produce pulse code modulation (PCM) signals as the output of the audio capturing and processing unit, and, under the control of the video recording control unit 24, send the PCM signals to the video recording control unit 24.

Furthermore, as shown in FIG.2, the video recording control unit 24 obtains status information from the video capturing control unit 23 and controls the analog-to-digital conversion of the video A/D unit in the video capturing and processing system and the digital YUV signal encoding and video code stream output of the video encoding unit, and controls the two audio A/D units in the audio capturing and processing system to convert analog audio signals to PCM signals and control the output of converted the audio signals.

As shown in the figure, the integrated video capturing/recording apparatus in this embodiment further includes a display unit 25, which is connected to the video recording control unit 24 via a VGA interface or a DVI interface to display video images.

The video recording control unit 24 is connected to the iVDR adapter 26 via S-ATA interfaces. As shown in FIG.2, the iVDR adapter is connected to the video recording control unit via two S-ATA interfaces and provides 2 bays for iVDR storage devices, so that two iVDR storage devices can be connected to the video recording control unit simultaneously to implement mutual backup, in order to ensure data safety; the adapter 26 can use an iVDR hard disk and an iVDR standard-compliant semiconductor card at the same time to record.

The being accessed from the two storage media simultaneously in this embodiment employs RAID 1 technology to access the two storage devices simultaneously.

Furthermore, in the embodiment of the present invention, when two storage devices in the iVDR adapter are connected to the video recording control unit, data can be written to the first and the second storage devices with RAID 1 technology in case that the space of the first storage device is to be used up; after the first storage device is full, it can be replaced with a third storage device, so as to implement long-time uninterrupted program data recording. In yet another embodiment of the present invention, the program data can be stored into a buffer unit before it is written to the storage devices, so that the buffer unit can buffer the acquired program data in case that the space in the first storage unit is full, and, when a second storage device is put into service, the program data in the buffer unit can be written into the second storage device; that method in the embodiment can also implement uninterrupted program data recording.

The iVDR (Information Versatile Disk for Removable Usage) is a brand new data storage platform standard available in the market for PCs and audio/video equipments, which defines basic parameters of removable storage devices, including description of hardware, interfaces, and file system, etc.; iVDR employs 26-pin female interfaces to support hot-swapping and meet the requirement for compatibility to serial interfaces; in addition, iVDR supports extended security instructions, (i.e., the hard disk has its own password and it will refuse to execute external instructions if the password provided by the user doesn't match the internal password) and thereby improves security of the file system; the existing iVDR hard disks are available in 4 sizes: 3.5″ (1″=2.54 cm) iVDR parallel, 2.5″ iVDR, 1.8″ iVDR mini, and 1″ iVDR macro. The iVDR adapter in the embodiment includes: the iVDR standard interfaces, configured to supply power to the hard disks when the iVDR storage devices are connected to the interfaces, and perform communication and data transmission; slots for iVDR storage devices; and in another embodiment of the present invention, the iVDR adapter can further include electromechanical devices or manual devices configured to secure the iVDR storage devices to the slots, so that the storage devices are connected firmly to the iVDR interfaces.

The iVDR storage device employs an S-ATA interface which employs embedded clock signals for the bus and has higher error correction capability, and thereby improves reliability of data transmission. Serial interface supports hot-swapping; on that basis, S-ATA employs pin-type interface protected with insulating material to prevent deformation of the pins of hard-disk interface resulted from incorrect insert/pull operations.

With the iVDR adapter described above, the hard disk or semiconductor card can be removed in the same way as a video tape, thereby, a new application pattern of hard disks or semiconductor cards is implemented; on one hand, as hard disk capacity and semiconductor card capacity grow quickly now, using a hard disk or a semiconductor card that can be removed and extended easily within the service life of the equipment can alleviate user's worry about backup and upgrade of storing device; in addition, since the system provides an iVDR adapter, using hard disks or semiconductor cards to store acquired program data in the video editing system is as convenient as using traditional video tapes but provides much higher capacity.

Furthermore, in the embodiment of the present invention, based on the structure described above, the integrated video capturing/recording apparatus can provide multiple external signal output interfaces, such as IEEE 1394 interface (including IEEE 1394A or IEEE 1394B), audio output interface, and Serial Digital Interface (SDI) interface.

In the embodiment described above, the video recording control unit can also be connected to the control input unit to obtain external control instructions; the control input unit can be implemented as control keys provided on the panel of the integrated video capturing/recording apparatus or an external keyboard; or, it can employs a touch screen to implement input of control instructions, i.e., with the existing touch screen technology, the display unit and control input unit described in the invention can be implemented.

The audio/video capturing and processing unit described in above embodiments belongs to a known technology in the field, and the implementation thereof will not be described in the present invention.

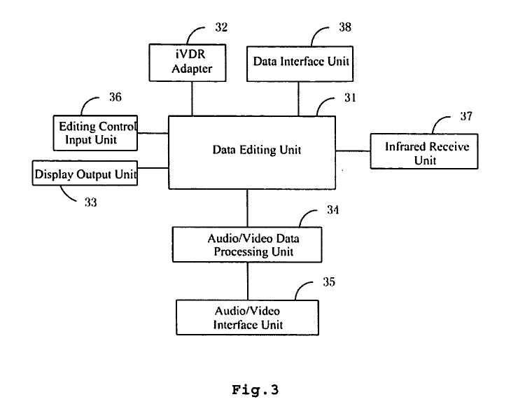

FIG.3 is a logic diagram of structure of the audio/video editing system according to an embodiment of the present invention. Hereunder the audio/video editing system according to the embodiment is described with reference to FIG.3.

As shown in FIG.3, the audio/video editing system includes data editing unit 31, iVDR adapter 32, display output unit 33, audio/video data processing unit 34, audio/video interface unit 35, editing control input unit 36, infrared receive unit 37, and data interface unit 38;

The data editing unit is used to edit audio/video data;

The structure of the iVDR adapter is the same as described above. The iVDR adapter is connected to the data editing unit; the data editing unit obtains program data in the semiconductor card or hard disk connected to the iVDR adapter via the interface provided by the iVDR adapter, and then edit the program data; in the storage devices iVDR hard disks and iVDR standard-compliant semiconductor cards can be used simultaneously, and program data can be accessed from the two storage media; thereby, multiple storage devices can serve as mutual-backup for each other, to ensure data safety;

The being accessed from the two storage media as described above can be implemented by employing RAID 1 technology to access the two storage devices simultaneously. Likewise, uninterrupted program recording can also be implemented with the same technology as used in the integrated video capturing/recording apparatus described above;

The display output unit is connected to the data editing unit and is used to provide the interface for program editing and display program images or relevant information;

The audio/video interface unit is connected to the audio/video data processing unit and provides external audio/video signal Input/Output (I/O) interfaces;

The audio/video data processing unit is connected to the data editing unit and the audio/video interface unit and is configured to convert audio/video signals inputted from the audio/video interface unit into program data in a format that can be recognized by the data editing unit and send the data to the data editing unit, or, convert the program data in the format that can be recognized by the data editing unit to audio/video signals and send the signals to the audio/video interface unit;

The editing control input unit is a control input unit described in the present invention; it is connected to the data editing unit through serial signal cables and provide external control keys for linear program editing or nonlinear program editing; after the instructions from the editing control input unit is sent to the data editing unit, the instruction mapping unit maps the instructions to operating instructions of the data editing unit, so that the data editing unit edits the program under the instructions.

The infrared receive unit is a control input unit described in the invention; it is connected to the data editing unit and is configured to receive signals from an infrared wireless keyboard/mouse and thereby provides control information to the data editing unit;

The data interface unit is connected to the data editing unit and provides external serial signal interfaces, Ethernet interface, and optical fiber interface, to connect an external control console or a network, so as to construct a system that can share resources with other networks, thus implementing network-based television program production, and making television program editing and spread more quickly and convenient.

based on the structure of the audio/video editing system described above, the control input unit further according to a further embodiment of the present invention includes keyboard and/or mouse that is connected to the data editing system via a serial interface; or, in another embodiment of the present invention, the control input unit can also be implemented with the existing touch screen technology, i.e., the touch screen provides the display output unit described in the invention to implement output of program images or operation interface as well as the control input unit described in the invention.

The data interface unit in the embodiment of the present invention can provide external serial signal interfaces, such as USB, IEEE 1394, or RS-422, RS-232, and RS-485 serial interfaces, etc.; in addition, the data interface unit can be further extended to provide external audio/video I/O interfaces on the data interface board, such as MIC jack or headphone jack. The USB standard includes USB 1.1 and USB 2.0 standards; the IEEE 1394 standard is a serial interface standard established by IEEE Standardization Organization, which supports video data transmission speed; the maximum data transmission rate of IEEE 1394a interface is 400 MBps, and the maximum data transmission rate of IEEE 1394b is up to 4 Gbps; the RS-422, RS-232, and RS-485 standards are serial data interface standards specified and issued by Electronic Industries Alliance (EIA), which only specify electric properties of the interfaces. The above interface standards are known technologies in the field.

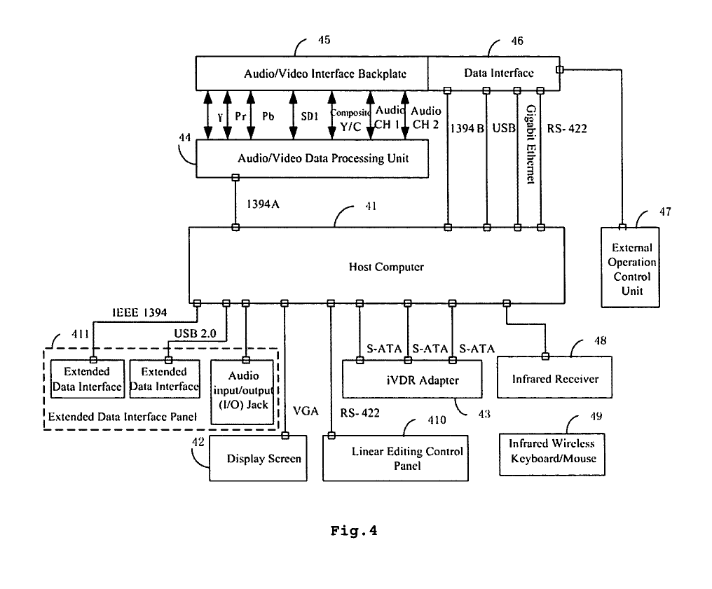

Hereunder the audio/video editing system according to a preferred embodiment of the present invention is described with reference to FIG.4; wherein, the system includes:

Host computer 41, the primary function of which is to edit program data;

Display screen 42, which functions as a display output unit, i.e., which is connected to the host computer via a VGA interface or a DVI interface to receive image signals from the host computer and display the images, and also provide operating interface and display other relevant information; the VGA interface is also referred to as D-sub interface, which has 15 pins arranged asymmetrically; the interface is a known technology in the field.

iVDR adapter 43; in the embodiment as shown in FIG.4, the iVDR adapter is connected to the host computer via three S-ATA interfaces and provides three bays for iVDR storage devices, so that up to three iVDR storage devices can be connected to the host computer at the same time; in the storage devices iVDR hard disks and iVDR standard-compliant semiconductor cards can be used simultaneously to record, and thereby, the program data can be accessed from the two storage media simultaneously; as the result, multiple storage devices can serve as mutual backup for each other to ensure data safety;

Audio/video data processing unit 44, which is connected to the host computer via an IEEE 1394 interface, and is connected to the audio/video interface backplate 45 (which provides function of the audio/video interface unit), so that the audio/video interface backplate provides external audio/video signal I/O interface; the audio/video data processing unit converts the audio/video (AV) signals inputted from the audio/video interface backplate into program data in a format that can be recognized by the host computer and sends the data to the host computer, and, converts the program data in the format that can be recognized by the host computer into audio/video signals and outputs the signals through the audio/video interface backplate;

As shown in FIG.4, the audio/video interface backplate in the embodiment provide the external audio/video signal interfaces:

Color Difference Signal (YUV) interface, which may be interleaved color difference signal (Y, Cr, Cb) interface or line-by-line color difference signal (Y, Pr, Pb), and is a known technology in the field;

Serial Digital Interface (SDI); SDI standard specifies the method of transmitting uncompressed serial digital video data between products and devices through a video coaxial cable; SDI standard is further classified into Standard Definition (SD) SDI and High Definition (HD) SDI by data rate;

Composite signal interface, which combines brightness, chroma and synchronization signals in a single transmission signal; composite video may be in PAL, NTSC, or SECAM system, depending on the color encoding; the bandwidth of composite video signals themselves is 5 MHz;

Besides the above external video interfaces, the audio/video interface backplate in the embodiment also provides a two-channel audio interface;

As shown in the figure, in the embodiment, the audio/video interface backplate also provides external data interfaces 46, which are used to connect external devices (e.g., external operation control unit 47) to the host computer. The data interfaces include a 1394B interface, two USB 2.0 interfaces, Gigabit Ethernet interface and RS-422 interface, and an optical fiber interface (FC) (not shown);

Infrared keyboard receiver 48, which is connected to the host computer via a serial interface (in this embodiment, a USB 2.0 interface), configured to receive control signals from an infrared wireless keyboard/mouse 49 and send the signals to the host computer, so that the host computer can perform editing operations for the program data according to the control information contained in the control signals.

Linear editing control panel 410 (providing function of an edit control input unit), which is connected to the host computer via a RS-422 serial interface and provides external functional control keys for linear editing; the host computer obtains instruction signals from the functional control keys of the edit control input unit and maps the instructions to data editing instructions of the host computer, and thereby performs program data editing operations.

Based on the structure described above, the editing system in the embodiment further provides an expanded data interface card 411 which provides an external USB interface, an IEEE 1394 interface, and an additional headphone jack or MIC jack on the data interface card.

The audio/video editing system in the embodiment described above can provide multiple program editing modes (mainly the following three modes) to technicians:

Mode 1: the audio/video file data comes from a removable hard disk in any one of the iVDR adapters or from a USB/IEEE 1394/LAN interface; after the host computer obtains the audio/video file data, a technician performs nonlinear editing for the program data with the operations of the mouse/keyboard or the edit control input unit, depending on the nonlinear editing software running on the host computer; after the program editing is completed, the edited program data can be outputted from the audio/video data processing unit and the audio/video interface backplate, or stored in the hard disk or the semiconductor card in a certain iVDR bay, or outputted via other IT interfaces.

Mode 2: audio/video (A/V) signals (including digital signals and analog signals) are inputted from the external, and are converted to program data, that can be recognized by the host computer, through the audio/video interface backplate and the audio/video data processing unit; then, the program data is edited nonlinearly with the control instructions from the editing control input unit or the keyboard/mouse, depending on the nonlinear editing software running on the host computer; after the program editing is completed, the program data is outputted through the audio/video data processing unit and the audio/video interface backplate, or stored in the hard disk or the semiconductor card in an iVDR bay, or outputted via other IT interfaces.

Mode 3: the audio/video data files are provided from the hard disks or semiconductor cards in the iVDR adapter; and the audio/video editing system according the embodiment is connected to a traditional linear editing video recorder via the audio/video interface backplate; the audio/video data in the hard disks or semiconductor cards is converted by the audio/video processing unit into audio/video signals and then outputted to the linear editing video recorder via the audio/video interfaces of the linear editing video recorder; in addition, the audio/video editing system in the embodiment can be connected to a linear editing video recorder via serial interfaces on the audio/video interface backplate, and the control instructions of the linear editing video recorder and the editing instructions of the computer can be mapped to each other with the instruction mapping function of the host computer, to implement mutual control between the audio/video editing system in the embodiment and the linear editing video recorder. In that system structure, the technician can perform traditional linear editing through the operating interface of the linear editing video recorder, and finally the finished program is outputted to magnetic tapes. The editing approach in Mode 3 takes full advantage of existing linear editing equipment and provides flexible editing means; since both hard disks (or semiconductor cards) and magnetic tapes can be used as the storage media in that mode, smooth transition from linear editing to nonlinear editing of broadcast television programs can be implemented and the traditional linear editing approach familiar to the technicians is kept at the same time.

The video recording apparatus, the integrated video capturing/recording apparatus, and the audio/video editing system provided in the embodiments of the present invention are described as above. In this document, the principle and implementation of the invention are described in specific embodiments, which are used only to facilitate the understanding of the apparatuses and key idea of the invention. It is understood that those skilled in the art can easily make modifications or variations to the embodiments and their applicability, without departing from the spirit of the invention; therefore, the description shall not be deemed as limits to the present invention.

1. A video recording apparatus, comprising:
an interface unit, configured to provide external program data input/output (I/O) interfaces;
a video recording control unit, configured to control the input/output of program data according to external control signals; and
an Information Versatile Disk for Removable usage (iVDR) adapter, connected to said video recording control unit via Serial ATA (S-ATA) interfaces, and configured to read/write program data from/to iVDR storage devices under control of the video recording control unit.

2. The video recording apparatus as in claim 1, wherein
said iVDR storage devices are iVDR hard disks or iVDR standard-compliant semiconductor cards.

3. The video recording apparatus as in claim 2, wherein
said video recording apparatus accesses the two storage devices simultaneously by utilizing RAID 1 technology.

4. The video recording apparatus as in claim 1, further comprising
a display output unit, connected to the video recording control unit via said interface unit, and configured to display images.

5. An integrated video capturing/recording apparatus, comprising an audio/video capturing and processing system and an audio/video recording system, wherein
said audio/video recording system comprises:
a video recording control unit, configured to obtain external control signals, and connected to said audio/video capturing and processing system to obtain audio/video data from said audio/video capturing and processing system;
an iVDR adapter, connected to said video recording control unit via Serial ATA (S-ATA) interfaces, and configured to read/write program signals from/to storage devices under control of the video recording control unit.

6. The integrated video capturing/recording apparatus as in claim 5, wherein
said storage devices are iVDR hard disks or iVDR standard-compliant semiconductor cards.

7. The integrated video capturing/recording apparatus as in claim 6, wherein
said integrated video capturing/recording apparatus accesses the two storage devices simultaneously by utilizing RAID 1 technology.

8. The integrated video capturing/recording apparatus as in claim 5, further comprising
an audio/video output unit, connected to the video recording control unit, and configured to display video images or output audio under control of the video recording control unit.

9. The integrated video capturing/recording apparatus as in claim 5, further comprising
a data interface unit, connected to said video recording control unit, and configured to provide external serial interfaces.

10. An audio/video editing system, comprising:
a data editing unit, a display output unit, a control input unit, and an iVDR adapter;
said data editing unit is configured to edit audio/video data, and is connected to said display output unit;
said control input unit is connected to said data editing unit, and the data editing unit obtains signals from the control input unit and performs corresponding data editing operations;
said iVDR adapter is connected to said data editing unit via Serial ATA (S-ATA) interfaces.

11. The audio/video editing system as in claim 10, further comprising
an audio/video data processing unit and an audio/video interface unit;
said audio/video data processing unit is connected to said data editing unit through a serial bus and configured for the conversion between audio/video signals and program data that can be recognized by said data editing unit;
said audio/video interface unit is connected to said audio/video data processing unit through video signal cables and is configured to provide external audio/video input/output (I/O) interfaces.

12. The audio/video editing system as in claim 10, wherein
said control input unit is a keyboard or a mouse connected to said data editing unit through a serial data bus.

13. The audio/video editing system as in claim 10, wherein
said control input unit further comprises an editing control input unit, which is connected to the data editing unit via a serial interface, and configured to provide external control keys for linear editing and control keys for nonlinear editing;
said data editing unit receives instructions from said editing control input unit, maps the instructions to operating instructions of said data editing unit, and performs the corresponding data editing operations.

14. The audio/video editing system as in claim 10, further comprising
an infrared receive unit, configured to receive control signals from an infrared keyboard or mouse and send said control signals to the data editing unit through the serial data bus.

15. The audio/video editing system as in claim 10, further comprising
a data interface unit, connected to said data editing unit, and configured to provide external serial interfaces.

16. The audio/video editing system as in claim 15, further comprising
an Ethernet interface.
